(19) United States
(12) Patent Application Publication
(10) Pub. No.: US 2002/0135188 A1
(43) Pub. Date: Sep. 26, 2002

(54) Electromagnetic lock device

(76) Inventor: Chih Chung Chang, Chong Ho City (TW)

Correspondence Address: Chih Chung CHANG, P.O. Box 10-69, Chong Ho, Taipei, 235, TW

(21) Appl. No.: 09/816,570

(22) Filed: Mar. 22, 2001

(51) Int. Cl. E05C 1/06

(52) U.S. Cl. 292/144

(57) ABSTRACT

An electromagnetic lock device includes a housing, a latch and a follower rotatably secured in the housing and having an arm engaged with the latch and having one or more pegs. A casing is secured in the housing and has a passage for receiving and exactly guiding the latch to engage into the door frame. A spindle is slidably engaged in and actuated by the coil and coupled to either of the pegs for rotating the follower to actuate the latch. An enclosure is secured in the housing for receiving the coil. A spring may be used to bias the spindle toward the follower.

### BACKGROUND OF THE INVENTION

1. Field of the Invention

The present invention relates to a lock, and more particularly to an electromagnetic lock device.

2. Description of the Prior Art

Typical electromagnetic lock devices comprise a spindle slidably received in an electromagnetic member, such as engaged in a coil of the electromagnetic member so as to be moved by the electromagnetic member. The spindle of some of the lock devices are directly used to latch the doors or the like. The other lock devices include a latch directly moved by the spindle so as to lock the doors or the like. The typical electromagnetic lock devices may not be effectively operated.

The applicant has developed an improved electromagnetic lock devices which has been issued as U.S. Pat. No. 6,079,755 to Chang, issued Jun. 27, 2000, and filed Jun. 7, 1999. The latch is slidably engaged on a pole, but may not be exactly guided to engage into the door or the like.

The present invention has arisen to mitigate and/or obviate the afore-described disadvantages of the conventional electromagnetic lock devices.

### SUMMARY OF THE INVENTION

The primary objective of the present invention is to provide an electromagnetic lock device which includes a latch guide to guide the latch to exactly engage into the door or the like to be locked.

In accordance with one aspect of the invention, there is provided an electromagnetic lock device comprising a housing, a casing secured in the housing and including a passage formed therein, a latch slidably received in the passage of the casing and guided to move inward and outward of the housing, a follower rotatably secured to the housing and including an arm extended therefrom and engaged with the latch for moving the latch inward and outward of the housing, the follower including a first peg extended therefrom, an electromagnetic member secured in the housing and including a coil, a spindle slidably engaged in and actuated by the coil, means for coupling the spindle to the first peg of the follower to move the latch inward and outward of the housing when the spindle is moved and actuated by the coil. The casing is provided and may be used for exactly and stably guiding the latch to engage into an object to be locked and to solidly lock the object to a door frame or the like.

The casing includes an opening formed therein and communicating with the passage thereof for allowing the arm of the follower to be engaged into the casing and to be engaged with the latch and to move the latch inward and outward of the housing.

The arm of the follower includes a head formed thereon and engaged through the opening of the casing in order to be engaged in the recess of the latch.

The housing includes a hole formed therein, and a cover secured to the housing and having an orifice formed therein, the casing includes a projection engaged into the hole of the housing and includes a hub engaged into the orifice of the cover of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of an electromagnetic lock device in accordance with the present invention;

FIG. 2 is a partial exploded view of the electromagnetic lock device;

FIGS. 3, 4 are plane schematic views illustrating the operation of the electromagnetic lock device; and

FIG. 5 is a plane schematic view illustrating the attachment of the electromagnetic lock device to a door or the like.

### DETAILED DESCRIPTION OF THE PREFERRED EMBODIMENT

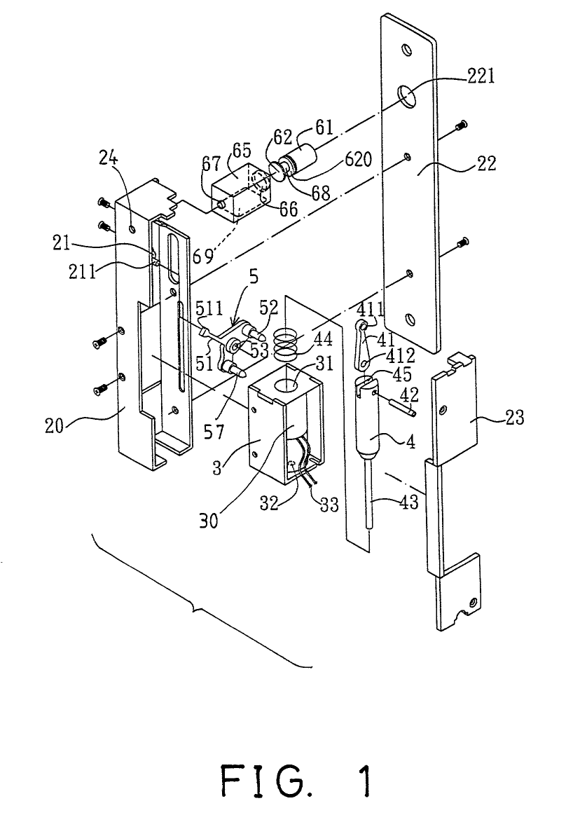

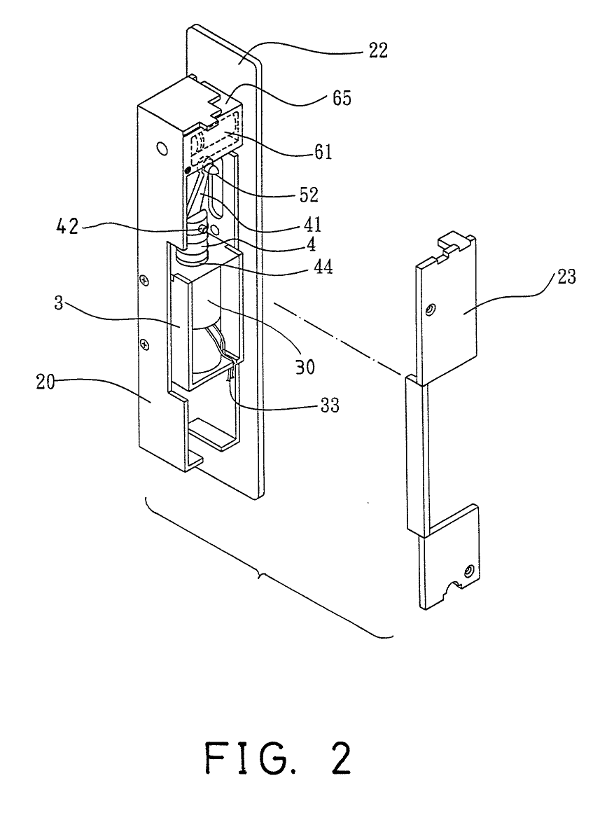

Referring to the drawings, and initially to FIGS. 1-3, an electromagnetic lock device in accordance with the present invention comprises a housing 20 including a seat 21 having a pin 211 extended therefrom and including a cap 23 detachably secured to the side portion thereof for enclosing the housing 20 and for retaining the elements within the housing 20. A cover 22 is detachably secured to the front portion of the housing 20 and includes an orifice 221 formed therein for slidably receiving a latch 61 therein. A follower 5 includes a hole 53 formed therein for rotatably securing the follower 5 to the housing 20 at the pivot pin 211. The follower 5 includes one or more pegs 52, 57 and an arm 51 extended therefrom. The arm 51 preferably includes a head 511 formed on the free end thereof for moving the latch 61 inward and outward of the housing 20 when the follower 5 is rotated. The pegs 52, 57 are extended from the follower 5 and spaced away from each other and spaced from the pivot pin 211 or the hole 53 of the follower 5. The arm 51 is located between the pegs 52, 57 or may be formed as a triangle together with the pegs 52, 57.

An enclosure 3 is secured in the housing 20 and includes a coil 30 of an electromagnetic member therein and includes a puncture 31 formed in the upper portion thereof for slidably receiving a spindle 4 therein and includes an aperture 32 formed in the lower portion thereof for slidably receiving an extension 43 that is extended from the spindle 4 and that includes an outer diameter smaller than that of the spindle 4. The aperture 32 includes an inner diameter smaller than that of the puncture 31 of the enclosure 3 for slidably receiving the extension 43 of the spindle 4 of the corresponding reduced size. The spindle 4 and/or the extension 43 of the spindle 4 are slidably engaged in the coil 30 which is coupled to an electric power supply by electric wires 33. The spindle 4 may be moved along a longitudinal direction by the coil 30 when the coil 30 is energized. The spindle 4 includes a slot 45 formed in the upper portion thereof. A link 41 includes a lower portion 412 received in the slot 45 of the spindle 4 and pivotally secured to the spindle 4 at a pivot axle 42 and includes an upper portion 411 that may be selectively coupled to either of the pegs 52, 57 of the follower 5. The pivot axle 42 preferably includes two ends extended outward of the spindle 4. A spring 44 is engaged on the spindle 4 and engaged between the pivot axle 42 and the enclosure 3 for moving the spindle 4 upward when the coil 30 has not been energized. Alternatively, without the spring 44, the spindle 4 may also be actuated upward and downward by the coil 30.

The above-described structure or the configuration of the electromagnetic lock devices has been described in U.S. Pat. No. 6,079,755 to Chang, issued Jun. 27, 2000, and filed Jun. 7, 1999, which is taken as a reference for the present invention.

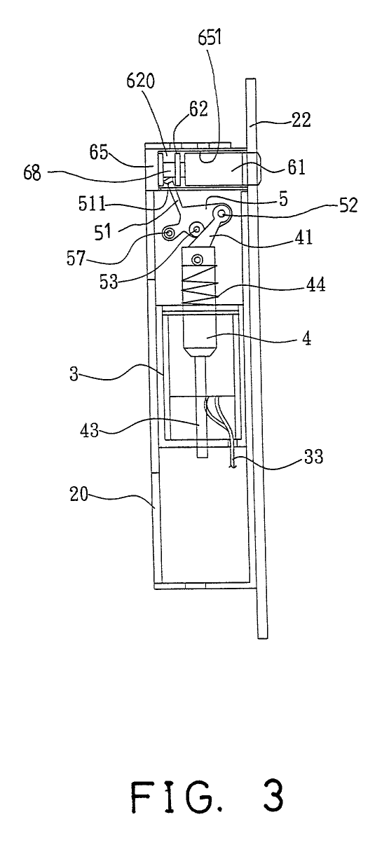

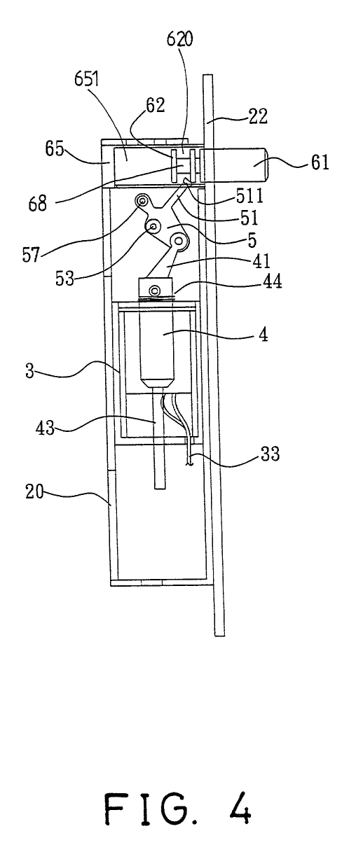

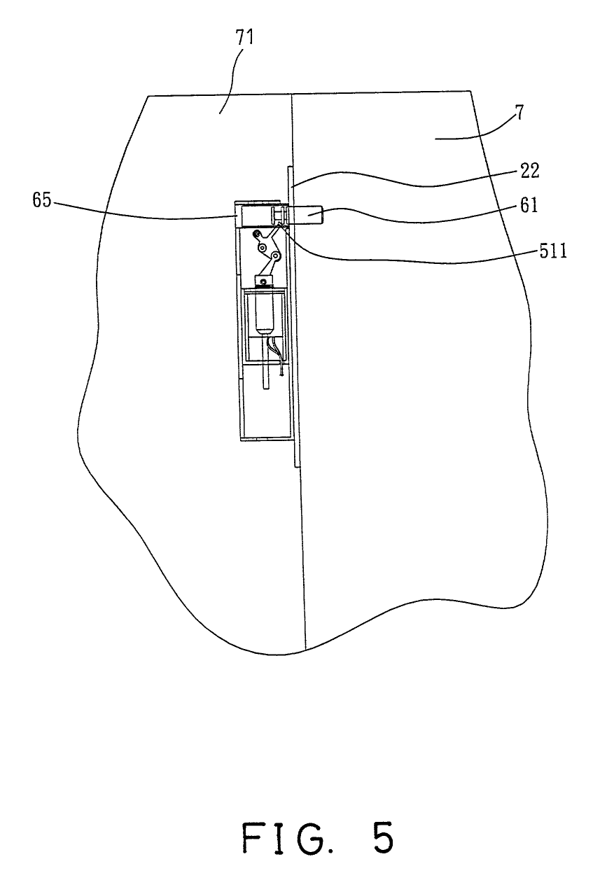

A casing 65 is secured to the housing 20, and includes a projection 67 laterally extended from one end thereof for engaging into or for securing into the hole 24 of the housing, and includes a hub 66 laterally extended from the end thereof and opposite to the projection 67 for engaging into or for securing into the orifice 221 of the cover 22 or of the housing 20, such that the casing 65 may be solidly secured in the housing 20. The casing 65 includes a passage 651 (FIGS. 3, 4) formed therein and formed through the hub 66 for slidably receiving and guiding the latch 61 to engage into a lock hole that is formed in the door panel 7 (FIG. 5). The latch 61 includes a stud 68 of a reduced diameter extended therefrom and an end stop 62 secured to the free end of the stud 68 for defining a cavity or an annular recess 620 between the latch 61 and the end stop 62 and/or around the stud 68. The head 511 of the arm 51 may be engaged into the recess 620 of the latch 61 for moving the latch 61 inward and outward of the housing 20 when the follower 5 is rotated. The casing 65 includes an opening 69 (FIG. 1) formed in the bottom portion thereof for allowing the head 511 of the arm 51 to be engaged into the recess 620 of the latch 61 and to move the latch 61 inward and outward of the housing 20.

In operation, as shown in FIG. 3, when the upper portion 411 of the link 41 is coupled to the peg 52 of the follower 5, for example, the latch 61 may be moved inward of the housing 20 by the arm 51 of the follower 5 when the spindle 4 is biased upward by the spring 44 and when the coil 30 has not been energized. As shown in FIG. 4, when the coil 30 is energized to move the spindle 4 downward against the spring 44, the latch 61 may be moved outward of the housing 20 to lock into the door 7 panel (FIG. 5) by the arm 51 of the follower 5 when the follower 5 is rotated clockwise by the spindle 4. The follower 5 may be rotated counterclockwise when the spring 44 bias the spindle 4 upward. The housing 20 may be secured in a door frame 71, and the latch 61 may be engaged into the lock hole that is formed in the door panel 7.

Alternatively, the upper portion 411 of the link 41 may be coupled to the other peg 57 of the follower 5, such that the latch 61 may be moved inward of the housing 20 by the arm 51 of the follower 5 when the coil 30 is energized, and such that the latch 61 may be moved outward of the housing 20 by the arm 51 of the follower 5 when the coil 30 is not energized or biased by the spring 44. The engagement of the link 41 with the other peg 57 and the operation of the latch 61 has also been described in U.S. Pat. No. 6,079,755 to Chang, issued Jun. 27, 2000, and filed Jun. 7, 1999, which is taken as a reference for the present invention.

It is to be noted that the latch 61 may be solidly and stably guided to move along the passage 651 of the casing 65, for allowing the latch to be guided to exactly engage into the door or the like to be locked.

Accordingly, the electromagnetic lock device in accordance with the present invention includes a latch guide to guide the latch to exactly engage into the door or the like to be locked.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electromagnetic lock device comprising:
a housing,
a casing secured in said housing and including a passage formed therein.
a latch slidably received in said passage of said casing and guided to move inward and outward of said housing,
a follower rotatably secured to said housing and including an arm extended therefrom and engaged with said latch for moving said latch inward and outward of said housing, said follower including a first peg extended therefrom,
an electromagnetic member secured in said housing and including a coil,
a spindle slidably engaged in and actuated by said coil,
means for coupling said spindle to said first peg of said follower to move said latch inward and outward of said housing when said spindle is moved and actuated by said coil,
said casing being provided to guide said latch to engage into an object to be locked by said latch.

2. The electromagnetic lock device according to claim 1, wherein said casing includes an opening formed therein and communicating with said passage thereof for allowing said arm of said follower to be engaged into said casing and to be engaged with said latch and to move said latch inward and outward of said housing.

3. The electromagnetic lock device according to claim 2, wherein said arm of said follower includes a head formed thereon and engaged through said opening of said casing in order to be engaged in said recess of said latch.

4. The electromagnetic lock device according to claim 1, wherein said housing includes a hole formed therein, and a cover secured to said housing and having an orifice formed therein, said casing includes a projection engaged into said hole of said housing and includes a hub engaged into said orifice of said cover of said housing.
